(19) United States
(12) Patent Application Publication
(10) Pub. No.: US 2019/0302692 A1
(43) Pub. Date: Oct. 3, 2019

(54) METHOD OF PREVENTING VIDEO CONTENT PIRACY

(71) Applicant: Kaled Sidik, Al-Nuzha (KW)

(72) Inventor: Kaled Sidik, Al-Nuzha (KW)

(21) Appl. No.: 15/942,904

(22) Filed: Apr. 2, 2018

(51) Int. Cl. G03H 1/00; G06F 21/10; G06F 21/62

(52) U.S. Cl. CPC G03H 1/0011; G06F 21/62; G06F 21/10

(57) ABSTRACT

A method of preventing piracy of video content. Video content is provided on a digital video content storage device, with authorized copies of the video content storage device including a designator of authenticity and a code which serves as a lottery number. The designator of authenticity includes an authorized signature that is readable by the naked eye only with UV light or magnification or enhancement, or is readable only by machine.

### FIELD OF THE INVENTION

The present invention relates generally to videotape cassettes, DVD disk, CD disk, HD movie disk or Blue Ray disk and more particularly to a method of preventing piracy of video/audio contents.

### BACKGROUND TO THE INVENTION

The piracy of audio and video content is a significant problem worldwide. For example, movie producers often spend millions of dollars to produce movies and distribute them in a variety of formats and media, only to have unscrupulous parties misappropriate the producer's lawful profit by distributing unauthorized copies of the production. These video content pirates have little, if any, cost associated with their production of counterfeit material, and are therefore able to price their product significantly below the cost associated with lawful enterprises.

In spite of attempts by various governments and trade groups to limit video content counterfeiting and piracy, the problem continues to expand. Recent figures by the MPAA indicate that at least $250 million in potential revenues are lost to video content pirates annually in the U.S. alone, while worldwide numbers are in excess of $4 billion. In fact, so significant is the problem to U.S. audio and video producers that intellectual property piracy has even been cited as the basis for trade sanctions against governments believed to take a less than effective approach to solving the problem.

It can be seen that a significant need exists for a method of thwarting video content piracy, therefore restoring to movie producers the profits they lawfully deserve. The present invention addresses this need.

### SUMMARY OF THE INVENTION

Briefly describing the present invention there is provided a method of preventing video content piracy by including on authorized copies of a digital video content storage device a designator of authenticity and a code which serves as a lottery number.

One object of the present invention is to provide a method of preventing video content piracy.

Further objects and advantages of the present invention will be apparent from the following description.

### BRIEF DESCRIPTION OF THE DRAWINGS

FIG. 1 shows one embodiment of the method for protecting digital video content from piracy by including on the housing or case of the digital video content storage device a designator of authenticity and a code which serves as a lottery number.

FIG. 2 shows one embodiment of a digital video content storage device case which includes a designator of authenticity and a code which serves as a lottery number.

FIG. 3 shows one preferred embodiment of a digital video content storage device, including a designator of authenticity and a code which serves as a lottery number.

### DESCRIPTION OF THE PREFERRED EMBODIMENT

For the purpose of promoting an understanding of the principles of the invention, reference will now be made to preferred embodiments and specific language will be used to describe the same. It will nevertheless be understood that no limitation of the scope of the invention is thereby intended, such alterations and further modifications in the illustrated embodiments, and such further applications of the principles of the invention as illustrated herein being contemplated as would normally occur to one skilled in the art to which the invention pertains.

As previously indicated, the present invention addresses the problem of video content piracy by including on authorized copies of a video content a designator of authenticity (such as an authorized signature of the owners) and/or a code which also serves as a lottery number. The lottery number makes the authorized copies of the video content more valuable than counterfeit copies, and provides an incentive for persons to buy only the genuine article. The designator of authenticity enables the producer or organizer of the lottery to verify that the winning lottery number was lawfully obtained.

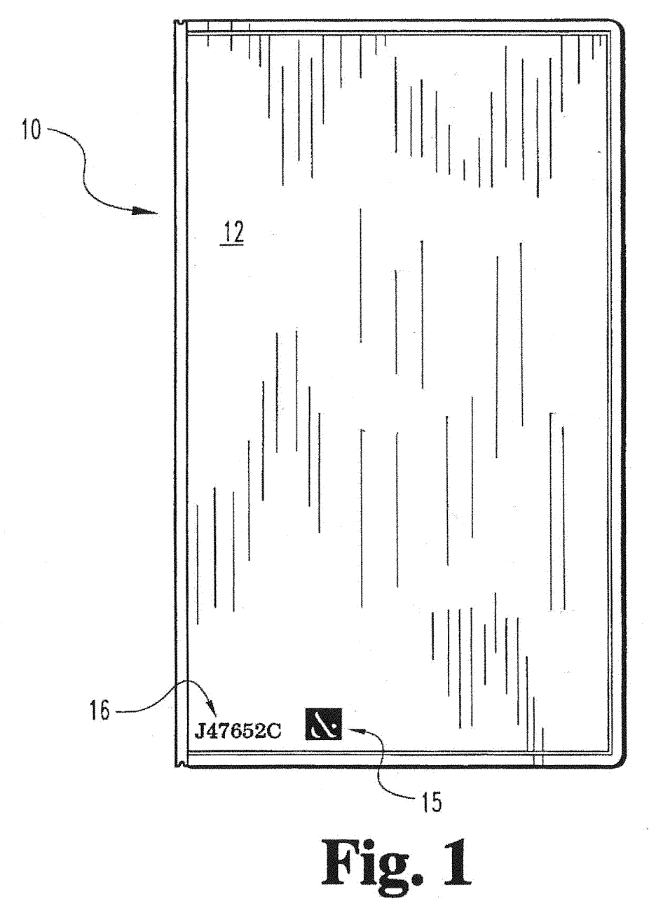

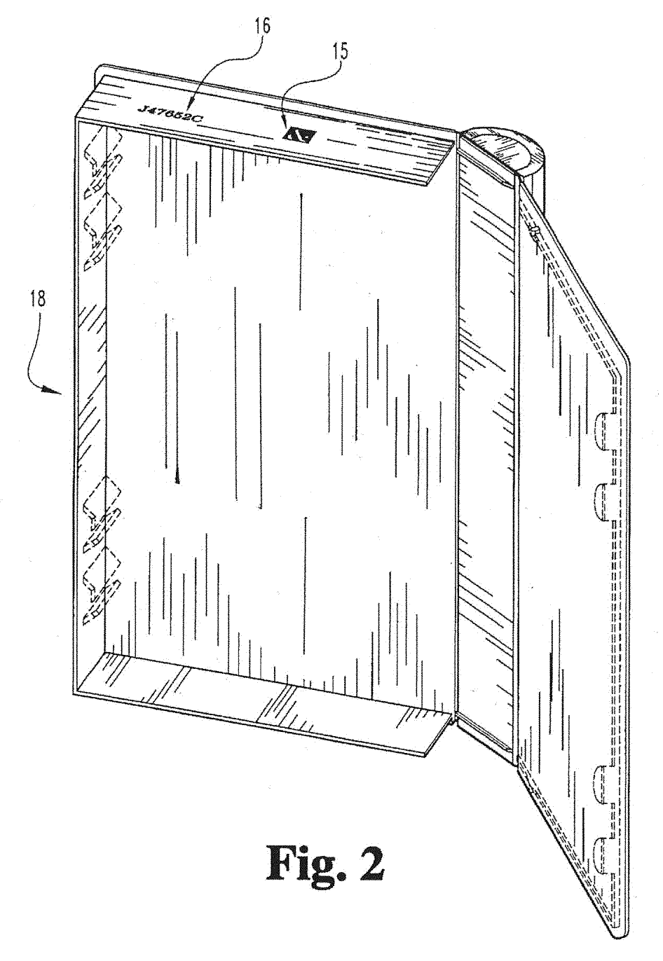

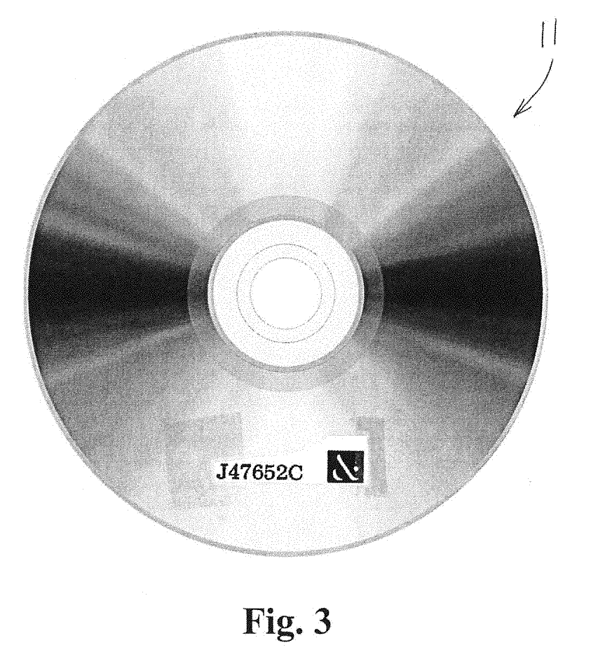

As shown in FIGS. 1-3, digital video content may be provided on a digital content storage medium 11 that is sold to consumers in a housing member 12, with a designator of authenticity 15 and lottery number 16 being included on housing member 12. It is to be appreciated that the inventive method may be applied to digital video discs and other digital video content storage devices, such as, but not limited to, digital video discs, in all formats.

The designator of authenticity may be visible or invisible to the naked eye, with or without aids such as magnification or UV light. The designator of authenticity should be difficult to reproduce by counterfeiters, but must be verifiable by the lawful producer of the tape. For example, in one preferred embodiment the designator of authenticity is a hologram. Other preferred embodiments include designators of authenticity that are readable only by machine, such as machine-readable magnetic tape, or a hidden signature of the lawful owner which could be read only by UV.

The designator of authenticity may be provided anywhere in or on the product, such as in or on the tape/disk itself, in or on the tape/disk housing, or in or on the packaging material. In one preferred embodiment the designator of authenticity is included both on the tape jacket and on the tape itself. For the purposes of this disclosure all methods of providing the designator of authenticity in or on the product or its packaging shall be referred to as providing the designator “on authorized copies” of the product.

For example, in one preferred embodiment the designator of authenticity and/or the lottery number are included on digital video content storage device case 18, while in another preferred embodiment the designator is provided on housing member 12. Alternatively, the designator of authenticity and/or the lottery number may be included on tape/disk member 11, in which case it may be viewable only through a tape/disk playing machine.

Lottery number 12 is also proved as described above. Here too, the number may be provided anywhere in or on the product or its packaging. Further, the lottery number may be part of the designator of authenticity or it may be separate and distinct from that element. Preferably, the lottery number is readily visible to the naked eye and is easily read by the purchaser of the tape/disk and is mentioned in the purchase receipt supplied by the dealer/seller. Most preferably the lottery number is provided on both the product and on its packaging.

As to the use of the aforementioned items to prevent video content piracy, one preferred method of using the designator of authenticity and the lottery number is to have a worldwide gala event that promotes the video/disk content and simultaneously acts as the lottery drawing. The gala event may be broadcast around the world (or at least to large, well-populated regions), and may include celebrity acts and other festivities. Most preferably, the lottery drawing would occur during the gala event so that maximum excitement about the drawing may be generated.

More particularly, one preferred embodiment of preventing videotape piracy by the method of the present invention is initiated when the producer makes a deal with a TV network to sponsor and/or host the worldwide premier of his “Movie,” presented within a show live via satellite. Each and every country of the world TV station that has agreed to participate will also transmit the same show with the movie to their regional audience, either simultaneously or delayed to allow for time differences. Representatives of these participating international TV stations will be invited in person as guests of the organizers to attend and judge the draw of the lucky winners on air. They can communicate with winners from their countries in their local language. This will boost the general public confidence in the program.

Within this gala show and the movie, lucky numbers are drawn, and valuable properties such as real estate in different parts of the world and other interesting prizes are given away to viewers/holders of lucky winning numbers from around the world. The gala presentation is only for drawing lucky winners of the real estates and other extravagant prizes and the telecasting of part of the movie. This gala show will be in English language, unless local authorities or host Network TV demand the regional language of the Network host city, or mixture of two languages. If the footprint of the Satellite Gala Night does not cover the total world areas (countries), this venue can be duplicated at a different date.

The picked lucky numbers correspond to numbers on the video contents/jackets marketed earlier in each country. Participating TV stations will broadcast this show along with the film in its original or local version.

Each videocassette is “Secret-Coded” by numbers and/or a hologram and/or an authorized signature (or any or all of those things) for the draw (raffles), and to avoid piracy. The buyers are advised to buy this legal and genuine copy to be eligible for the draw, also emphasized in the commercials shown on TVs earlier. The sales and the publicity campaign of the video content will commence worldwide simultaneously one year before the gala draw night, in arrangement with the local TV stations, the sellers of the video content and the distributors. Preferably, distributors will promote the sale of the video content in their territory by airing promotional spots in their local market.

As indicated, to entice worldwide participation in the contest real estate properties in different parts of the world are selected as major prizes. In order to glamorize the show and make it interesting to an international audience, celebrities/stars and/or representatives of the participating TV stations of the world should be included in the show.

TV stations preferably air the movie from a single feed during the show. If satellite cost and the time differences make that strategy prohibitive, each TV station may be supplied with a broadcast quality tape of the movie free of charge against telecasting the commercials of the movie itself. These stations can air the show and the movie at their preferred times. They can re-voice the video content in their local language. Alternatively, only the drawing process via satellite is transmitted live. This will update the worldwide audience of the lucky winners. Each winner will come or contact his/her regional TV station, where he/she is interviewed for a live broadcast via satellite within the gala show on air. The TV station can also subtitle the video/movie content in their local language, if their trend is so.

Embassies can contribute by introducing the project and the producer to governments and local TV authorities internationally. In turn, each TV station will help the producer in contacting and negotiating a deal with a local videocassette distributor(s). Priority of distribution is given to the TV station itself also against a percentage of net the sales. The task of international distribution of the video content can also be delegated to a reputable home video distributor with international contacts against a fee or a percentage of the net sales. Alternatively, the video content may be distributed through the producer's own sources or contacts.

The prizes and the show can also be underwritten by an internationally renowned bank/corporation to boost public confidence in the contest. These enterprises may also contribute cash prizes in exchange for advertising associated with the international marketing campaign.

Finally, the producer of the movie and the distributor of its video content should agree on an accounting strategy and the selling price of video content. All unsold videocassettes/disks and/or their lottery numbers should be accounted for and returned to the producer prior to the gala draw night. These returned and unsold lottery numbers will not be included in the draw. Commercial slots within the show and the film could also be sold to other interested parties or sponsors. A quantity of un-marked/un-numbered/un-coded but authorized copies of the video content will represent free giveaways as a PR gesture. These will not be eligible to enter the draw and the numbers will not be included in the draw.

In the foregoing description is has been disclosed that the gala event may be broadcast around the world, or at least to several large, well-populated regions. For the purposes of this disclosure large, well-populated regions include, but are not limited to, metropolitan areas in North America, South America, Europe, Asia and the middle-east. All cities with populations in excess of 100,000 persons are considered to be metropolitan areas. Thus, for the purposes of this disclosure, “worldwide” broadcast is contemplated to include an international broadcast to at least two cities with populations in excess of 100,000 persons each.

It is to be appreciated that the foregoing method may be used to prevent the piracy of videotapes, videodisks of different formats, audiotapes, computer software, books or any other materials or products which have a value separate and distinct from their lottery ticket value.

While the invention has been illustrated and described in detail in the drawing and foregoing description, the same is to be considered as illustrative and not restrictive in character, it being understood that only the preferred embodiment has been shown and described and that all changes and modifications that come within the spirit of the invention are desired to be protected.

1. A method of preventing piracy of video content, said method comprising providing a video content on a digital video content storage device and including on authorized copies of said video content storage device a designator of authenticity and a code which serves as a lottery number; wherein said designator of authenticity comprises an authorized signature that is readable by the naked eye only with uv light or magnification or enhancement, or is readable only by machine.

2. A method according to claim 1 wherein said digital video content storage device comprises a digital video disc.

3. A method according to claim 1 and further including the step of holding a lottery to select one or more winning lottery numbers.

4. A method according to claim 2 wherein the step of selecting said winning lottery numbers is broadcast.

5. A method according to claim 1 wherein the designator of authenticity is readable with the naked eye only with magnification or enhancement.

6. A method according to claim 2 wherein the selection of the winning lottery number is broadcast during a performance of the material contained on the videotape.

7. A method according to claim 2 and further including the step of awarding a real estate prize to the holder of at least one winning lottery number.

8. A method according to claim 7 and further including the step of awarding a real estate prize to more than one holder of a winning lottery number.

9. A method according to claim 8 wherein said real estate prizes are located in many of the regions in which the lottery winner selection is broadcast.

10. A method according to claim 1 wherein the designator of authenticity additionally comprises a hologram.

11. A method according to claim 1 wherein the designator of authenticity is readable only with UV light.

12. A digital video content storage device that is protected against videotape piracy, comprising a digital video content storage medium housed in a housing member, wherein said housing member is marked with a designator of authenticity and a code which serves as a lottery number; wherein said designator of authenticity comprises an authorized signature that is readable by the naked eye only with uv light or magnification or enhancement, or is readable only by machine.

13. The digital video content storage device of claim 12 wherein the designator of authenticity is readable with the naked eye only with magnification or enhancement.

14. The digital video content storage device of claim 12 wherein the designator of authenticity additionally comprises a hologram.

15. The digital video content storage device of claim 12 wherein the designator of authenticity is readable only with UV light.

16. A digital video content storage device that is protected against videotape piracy, comprising a digital video content storage medium, a housing member, and a case member, wherein said case member is marked with an designator of authenticity and a code which serves as a lottery number; wherein said designator of authenticity comprises an authorized signature that is readable by the naked eye only with uv light or magnification or enhancement, or is readable only by machine.

17. The digital video content storage device of claim 16 wherein the designator of authenticity is readable with the naked eye only with magnification or enhancement.

18. The digital video content storage device of claim 16 wherein the designator of authenticity is a hologram.

19. The digital video content storage device of claim 16 wherein the designator of authenticity is readable only with UV light.
